(19) United States
(12) Patent Application Publication
(10) Pub. No.: US 2006/0167701 A1
(43) Pub. Date: Jul. 27, 2006

(54) Estate group purchasing matching system

(75) Inventor: Kiyoto Horimoto, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: NEED INC., Tokyo (JP)

(21) Appl. No.: 10/528,449

(22) PCT Filed: Sep. 19, 2003
(86) PCT No.: PCT/JP03/11991

§ 371 Date: Mar. 18, 2005

(30) Foreign Application Priority Data
Sep. 20, 2002 (JP) 2002-311870

(51) Int. Cl. G06Q 99/00

(52) U.S. Cl. 705/1

(57) ABSTRACT

In a network where a person who wants to sell an estate is connected to an estate purchase broker so that data communication can be performed, there is provided a database of information on estates to be sold which are provided by a person who wants to sell an estate, an estate purchase broker, and the like. An estate group purchasing matching system includes search condition setting means for analyzing a purchase condition described by a person who wants to purchase an estate and his/her attribute information and setting a condition for searching a person who roughly corresponds to it. In the search condition set by this search condition setting means, a priority degree of condition is quantified for each of the items and a search condition having a certain width is set for each item value. Thus, it is possible to extract a plurality of registered candidates who want to purchase an estate from the database containing estate purchase desirer information connected to the network by estate purchase desirer brief extraction means.

### TECHNICAL FIELD

The present invention relates to an estate group purchasing matching system in which a person who desires to purchase a real-estate property uses a data communication network to register information of desired conditions with the network, thereby enabling the person to purchase the property matching the desire in a short period.

### BACKGROUND ART

FIG. 13 is a diagram illustrating a conventional flow of subdividing land to sell in lots, where an estate sales desirer 1 requests an estate purchase broker 2a for brokerage of the sale of a property that the desirer 1 owns. The estate purchase broker 2a provides information of the property to a group to which the broker 2a belongs as a distribution property.

The estate purchase broker 2a negotiates with a subdivision business owner 3 who desires to purchase the property. After the establishment of a contract, the subdivision business owner 3 carries out designing and planning, and sells houses on the subdivision through brokerage of an estate sales broker 2b, etc.

The estate sales broker 2b recruits purchase desirers 4 through registration with an affiliated property database 5, etc.

The estate purchase desirer 4 searches properties registered with the property database 5 with which the estate sales broker 2b is affiliated for a desired property. When there is a property matching desired purchase conditions of the estate purchase desirer 4, the estate sales broker 2b negotiates the sale price and so on, and the subdivision business owner 3 and the estate purchase desirer 4 contract the sale.

The property database 5 is on the general internet for establishment of a contract between a seller and a buyer.

The conventional distribution of subdivision property is configured as described above. Therefore, it is difficult for an estate purchase desirer to efficiently find a property matching the desired conditions, resulting in a problem that the estate purchase desirer should collect information from many estate sales brokers that install property databases before finding the property matching the desired conditions.

Further, for an estate purchase broker, even if a property desired to sell is registered with a property database, when the property database is installed in distribution mechanisms of a limited extent, a frequency of access from an estate purchase desirer is low, and it is difficult to sell the property early. Thus, for the estate purchase broker, there are issues such that the close rate per estate purchase desirer is low, and that significant efforts and time is required to establish the contract.

Similarly, for a subdivision business owner, in product-out type distribution formed of purchase of a property and subdivision sales, risks always exist such that a sales period of the property is uncertain, and that the possibility of unsold property is present. Further, even if the property is registered with a property database of an estate sales broker, when the property database is installed in distribution mechanisms of a limited extent, a frequency of access from an estate purchase desirer is low, it is difficult to sell the property early, and also for the subdivision business owner, there are issues such that the close rate per estate purchase desirer is low, and that significant efforts and time is required to establish the contract.

Desired for estate purchase with high close rate is a system enabling an estate purchase desirer to efficiently find a desired estate in a short time based on an information database having-abundant items input from estate sales brokers and the estate purchase desirers, and a property database having abundant items input from estate purchase brokers.

### DISCLOSURE OF INVENTION

It is an object of the present invention to obtain an estate group purchasing matching system in which a person who desires to purchase a property is capable of efficiently finding the property matching various desired purchase conditions without repeating trials and errors in search, a person who desires to sell a property is capable of selling the property desired to sell in a short period, and an estate purchase broker and an estate sales broker are capable of having a high close rate per customer, and saving a lot of efforts and time required before completion of a contact.

On a network where estate sales desirers and estate purchase brokers are connected to enable data communications therebetween, with respect to a property of a database of for-sale property information provided from the estate sales desirers, the estate purchase brokers and so on, an estate group purchasing matching system of the present invention has a search condition setting means for analyzing desired purchase conditions and purchase desirer attribute information described by an estate purchase desirer, and setting conditions to search for a purchase desirer generally corresponding to the property, where each of the search conditions set by the search condition setting means has a quantified priority of the condition, and by search condition setting for providing a numeric value of the condition with a certain width, it is possible to extract a plurality of candidate purchase desirers, which are estate purchase desirers registered by an estate purchase desirer general extraction means, from a database with which is registered information of the estate purchase desirers connected to the network.

Each of the conditions is analyzed by a desired condition analysis means with respect to each of a plurality of estate purchase desirer general candidates extracted by the estate purchase desirer general extraction means, and it is possible to combine estate purchase general candidates to group corresponding to the property that is arbitrarily set. There is provided a property processing means for assuming group purchasing general candidates matching the corresponding candidate property again from the group of the estate purchase general candidates narrowed by the desired condition analysis means, and processing the land of the property to meet the desire of each of the candidates.

In the estate group purchasing matching system according to the invention, purchase desirer information of estate purchase desirers is obtained by analyzing the estate desired purchase conditions and estate purchase desirer attribute information described in natural language by the purchase desirer.

Further, in the estate group purchasing matching system according to the invention, an estate purchase desirer storage means describes a numeric value of a priority of each item of the estate purchase desirer information described in natural language.

When not described, descriptions in natural language are analyzed, and portions indicating priorities are analyzed to judge priorities in the desired conditions of the purchase desirer.

In the estate group purchasing matching system according to the invention, the estate purchase desirer storage means uses numeric values of priorities when the desired purchase conditions are assigned the numeric values of priorities, while using numeric values of priorities judged in the estate purchase desirer general extraction means by analyzing the purchase desirer conditions to determine the numeric values of properties of the desired purchase conditions, when the numeric values of properties are not assigned.

Thus, the estate group purchasing matching system according to the invention is provided with the desired condition analysis means for analyzing details of the information of desired purchase conditions and the purchase desirer attribute information stored in the estate purchase desirer database, and narrowing, to group estate purchase general candidates corresponding to the conditions set by the search condition setting means, a plurality of estate purchase desirer candidates extracted by the estate purchase desirer general extraction means in a plurality of estate purchase desirer candidates meeting the search conditions extracted by the estate purchase desirer general extraction means using the search condition setting means corresponding to each of arbitrarily set properties, in a purchase desirer information database organized by the estate purchase desirer general extraction means.

The estate purchase desirer general extraction means of the estate group purchasing matching system according to the invention is provided with a system for quantifying priorities to assign to information as to whether a desired property is a land or a house with the land, information of desired railroad, information of desired station, and information of desired property price.

Further, the estate purchase desirer general extraction means of the estate group purchasing matching system according to the invention has a system for quantifying degrees of attribute conditions including a name, age, current address, telephone-number, e-mail address, family structure, occupation, place of work and years of continuous employment, annual income, presence or absence of initial deposit, motive of the desire for purchase, and information of whether the current house is an own house or not.

Moreover, the estate group purchasing matching system according to the invention has the search condition setting means for analyzing information of the property database, quantifying the priorities, and setting conditions to search for an estate purchase desirer corresponding to the priorities.

### BRIEF DESCRIPTION OF DRAWINGS

FIG. 1 is a block diagram illustrating a configuration of an estate group purchasing matching system according to one embodiment of the present invention;

FIG. 2 is a flowchart illustrating the flow of processing in the estate group purchasing matching system according to the one embodiment of the present invention;

FIG. 3 is a view to explain the flow of a database of estate purchase desirers according to the estate group purchasing matching system according to the one embodiment of the present invention;

FIG. 4 is a view to explain the flow of a database of estate sales desirers according to the estate group purchasing matching system according to the one embodiment of the present invention;

FIG. 5 is a diagram illustrating a schematic configuration of an estate trading system including a preferable example of property processing means;

FIG. 6 is a view showing an example of an input screen used in the estate trading system of FIG. 5;

FIG. 7 is a view showing examples of parcel patterns used in the estate trading system of FIG. 5;

FIGS. 8(a) to 8(b) are views to explain parcels in the estate trading system of FIG. 5;

FIG. 9 is a flowchart to explain procedures in the estate trading system of FIG. 5;

FIG. 10 is a graph showing an example of distribution of the number of desirers with respect to a property to sell used in the estate trading system of FIG. 5;

FIG. 11 is a graph showing another example of distribution of the number of desirers with respect to a property to sell used in the estate trading-system of FIG. 5;

FIG. 12 is a view illustrating a change in 3-D house images according to a change in property line of parcels; and

FIG. 13 is a diagram to explain conventional procedures in estate trade.

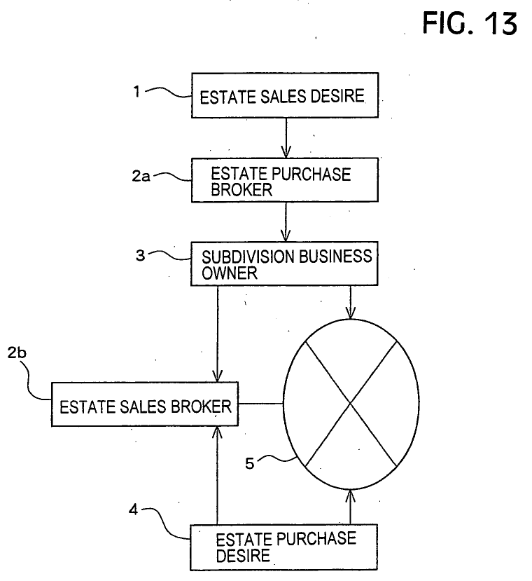

### BEST MODE FOR CARRYING OUT THE INVENTION

One embodiment of the present invention will be described below with reference to accompanying drawings.

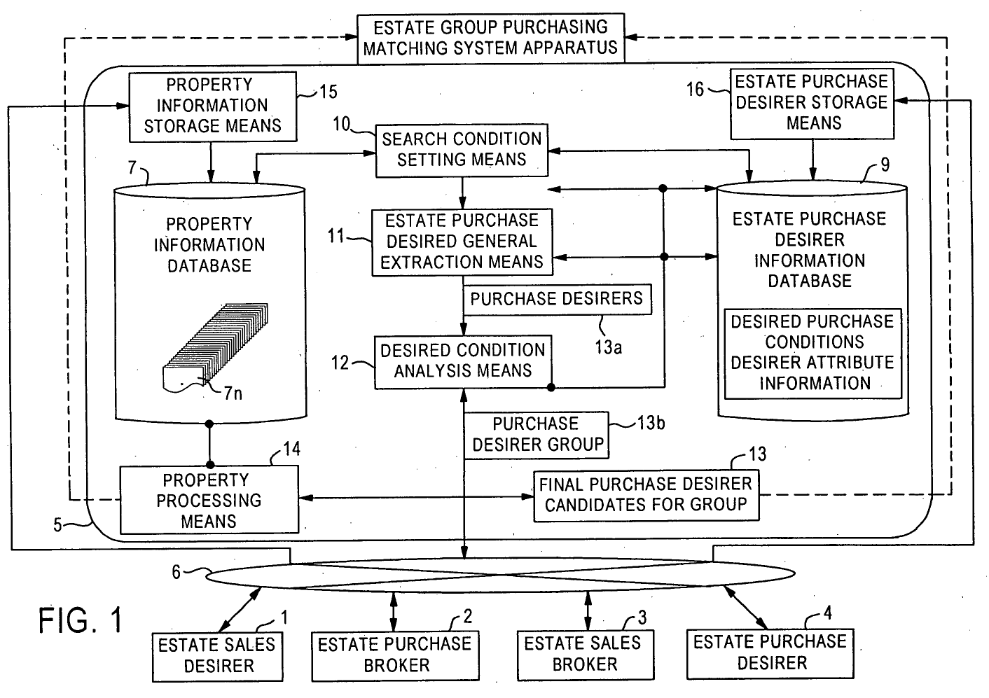

FIG. 1 is a block diagram illustrating a configuration of an estate group purchasing matching system according to one embodiment of the present invention. In the figure, “1” denotes a person who desires to sell a real-estate property that the person owns, “2” denotes an estate purchase broker who deals with the property that the seller 1 desires to sell, “3” is an estate sales broker that deals with a property of a purchase desirer, “4” denotes a purchase desirer who desires to purchase a property, “7” denotes a property database with which the estate sales desirer 1 registers the property to sell, and “6” denotes an information network. The network 6 is assumed to be connected to estate sales desirers 1, estate purchase brokers 2, estate sales brokers 3, and estate purchase desirers 4.

Further in FIG. 1, “5” denotes the system, and the system 5 is a property search apparatus which directly searches for properties desired by the estate sales brokers 3 and estate purchase desirers 4 to enable matching with information of the estate sales desirers 1 and estate purchase brokers 2 via the network 6. In the system 5, “9” denotes a database of desired purchase conditions and purchase desirer attribute information which is described by the estate sales brokers 3 and estate purchase desirers 4 in natural language, transmitted via the network 6 and organized by an estate purchase desirer database storage means.

“7” denotes a database of properties for sale which are described by the estate purchase desirers 1 and estate purchase brokers 2 in natural language, transmitted via the network 6 and organized by a property database storage means.

“10” denotes a search condition setting means for searching the superiority of a property numerically and setting conditions of the property. The search condition setting means arbitrarily sets a property 7n, and quantifies the priority of each of the conditions, while providing each condition with a certain width by making the condition constant or variable. “11” denotes an estate purchase desirer general extraction means for roughly extracting a plurality of estate purchase desirers by expanded search conditions obtained by providing the set conditions with certain widths in the search condition setting means 10. “12” denotes a desired condition analysis means for analyzing the estate purchase desirer general extraction means, and thereby setting the reduced number of a plurality of purchase estate desirers to combine. “13” denotes a plurality of purchase candidates grouped by “12” corresponding to an arbitrary one of 7n. In the apparatus, the database 7 with a plurality of properties is accessed via the network 6, and a plurality of estate purchase desirers 13 is extracted from registered estate purchase desirers, with respect to the property set by the search condition setting means 10 corresponding to each of the properties, and is combined for matching in the desired condition analysis means 12 so that each desire is satisfied.

In the group purchasing matching apparatus 5, “14” denotes an estate processing means for analyzing again the conditions of each of the plurality of estate purchase desirers 3 which are analyzed by the desired condition analysis means 12, and processing the property so as to satisfy the desires of estate purchase general candidates for group purchase.

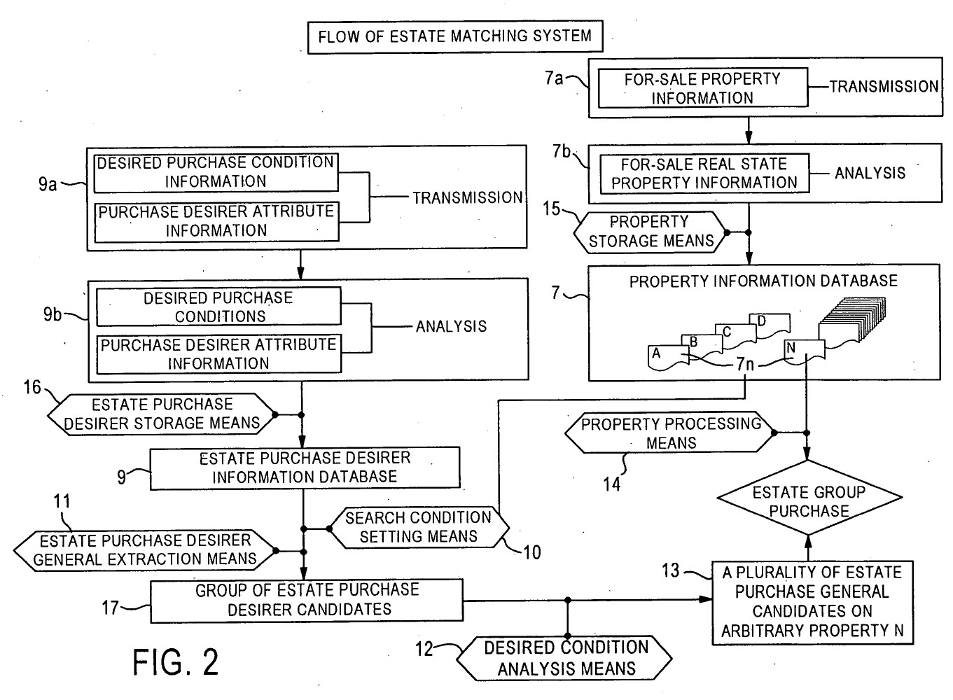

The flow will be described below. FIG. 2 is a flowchart illustrating the flow of processing in the estate group purchasing matching system according to the first embodiment of the invention. Desired conditions and attribute information of a purchase desirer is transmitted in 9a. In 9b, the reception site analyzes and organizes the content of transmission data, and files the data with the estate purchase desirer information database 9. The search condition setting means 10 arbitrarily chooses a property from the estate sales desirer information database 7, and selects search conditions corresponding to the property 7. According to the search conditions, the estate purchase desirer general extraction means performs narrowed analysis, and selects a plurality of estate purchase desirer candidates.

Meanwhile, an estate sales desirer transmits for-sale property information in 7a. In 7b, the information is received, organized, analyzed and filed with the estate sales desirer information database 7.

With respect to the property 7n arbitrarily chosen from the estate sales desirer information database 7, the estate purchase desirer general extraction means 11 selects a plurality of estate purchase desirer candidates, and the desired condition analysis means 12 groups from the candidates a plurality of purchase general candidates for the plurality 7n.

The property processing means 14 processes the property 7n so that the property 7n matches the desired conditions of the plurality of purchase general candidates for the property 7n grouped by the desired condition analysis means 12 so as to allow group purchase of the property, thereby enabling completion of a trade contract of the property 7n in a short time. Described above is the basic flow in the estate group purchasing matching system.

In FIG. 1, an estate purchase desirer transmits desired purchase conditions for purchase of a desired property and customer information to the system apparatus 5 via the network 6. In this case, the estate purchase desirer 4 describes the desired purchase conditions and customer information in text in natural language as in e-mail, instead of describing in specific format.

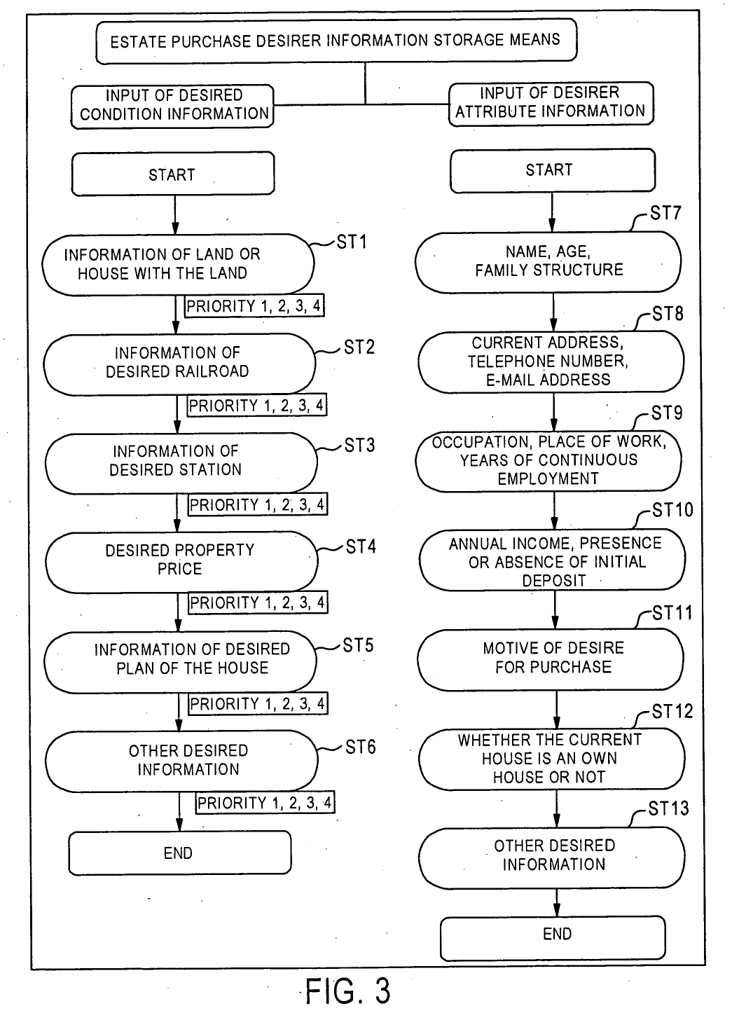

FIG. 3 illustrates the flow of content for the estate purchase desirer 4 to describe. As the desired purchase conditions to describe, the desirer describes whether to desire a land or a house with the land in step ST1, and further describes a priority of this condition using number 1, 2, 3 or 4 arranged in descending order of importance.

Described in step ST2 is a desire for the railroad nearby a property. The priority determined in relation to commute time and family is described using number 1, 2, 3 or 4. In each of steps ST1 to ST6, the priority is described using number 1, 2, 3 or 4.

Described in step ST3 are a desired station and the reason for the station.

Described in step ST4 is a sale price of a property.

Described in step ST5 are an area of a house and a floor plan of the house.

As well as the aforementioned desired conditions, desired purchase conditions described in step ST6 include environments of the location of a property, information of facilities such as a hospital, nursery and kindergarten, information on the presence or absence of facilities offering convenience to life such as a supermarket, school and bank, and information of the presence or absence of facilities that are not desired to exist nearby a property such as a garbage incineration plant.

Further, in step ST7 to describe estate purchase desirer attribute information, described are a name, age, and family structure of the estate purchase desirer and age(s) of family member(s).

Described in step ST8 are a current address, telephone number and e-mail address.

Described in step ST9 are an occupation, place of work, and years of continuous employment.

Described in step S10 is information including initial deposit in purchasing a property, and the correspondent financial institute.

Described in step ST11 is a motive for purchase of a property, and described in step ST12 is as to whether the current house is an own house or not.

Step ST13 is processed according to the need of description of other attribute information.

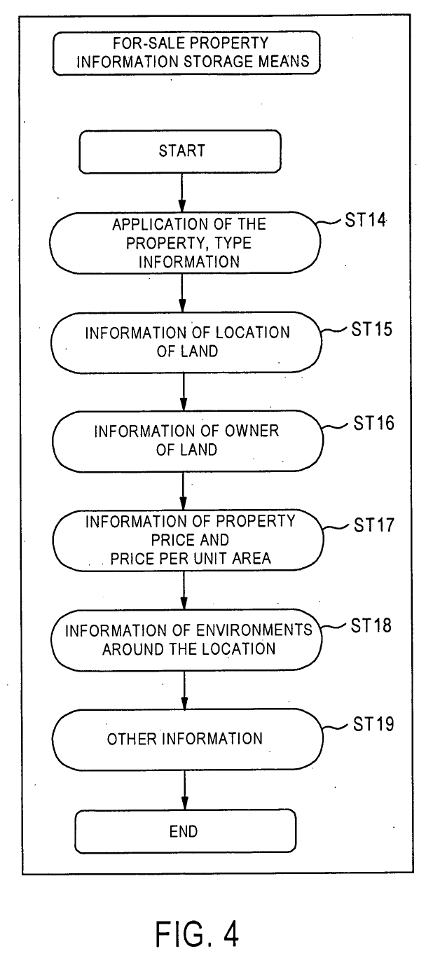

FIG. 4 illustrates the flow of content for the estate sales desirer 1 to describe. Also with respect to information of a property for sale, as described above, described first in step ST14 are an application of the property for sale and information of the type.

Next, in ST15, described is a location of the property. Descried in step ST16 is information of the owner of the property.

Described in step ST17 is information of price per unit area of the land and a desired price for sale.

Described in step ST18 is information including environments related to the location of the property.

Described further is necessary information as other information.

The desired purchase conditions and customer information which is described in natural language and transmitted from the estate purchase desirer 3 is converted into a predetermined need format to analyze and organize. The format is also used to enable the desired purchase conditions and customer information to be linked to the property database.

With respect to the desired purchase conditions described in natural language, an estate purchase desirer input means 16 in FIG. 1 analyzes the content of descriptions in natural language indicating priorities 1 to 4, describes the content indicating the priorities in specific format to convert, judges the priorities, and sets a grouping search condition. Therefore, the customer is capable of describing desired conditions for purchase of a property in predetermined fields with piece of mind to express in ordinary sentence without worrying.

In FIG. 2, the estate purchase desirer general setting means 11 stores estate purchase desirer information in an estate purchase desirer candidate group information data base 17 in FIG. 2. The estate purchase desirer information is obtained by analyzing desired purchase conditions in the estate purchase desirer database based on the grouping search condition corresponding to the property 7n set by the search condition setting 10, grouping desirers, and converting data of the desirers into a predetermined format.

In FIG. 2, the desired condition analysis means 12 analyzes in detail a plurality of estate purchase desirer candidates stored in the estate purchase desirer candidate information for each group, and converts the data into a format enabling comparison between data of a plurality of candidates for group purchase to set, in conjunction with the setting of candidates for estate purchase corresponding to 7n arbitrarily set by the search condition setting means 10 from the for-sale property information. At this point, the desired condition analysis means 12 uses the priorities judged by the estate purchase desirer general extraction means 11, and when a priority is not given and the estate purchase desirer general extraction means 11 cannot judge the priority, determines the priority from the sequence of descriptions of the desired purchase conditions.

Further, the desired condition analysis means 12 examines, for example, another desire, corresponding to the desired purchase conditions of the customer.

In FIG. 2, a plurality of estate purchase general candidate information 13 selected by the desired condition analysis means 12 is obtained by combining to extract a plurality of general candidates from desirers registered with the estate purchase desirer candidate information grouped by the estate purchase desirer general extraction means 11, using an analysis condition obtained by expanding an analysis condition set by the desired condition analysis means 12 to provide a certain width.

In FIG. 2, the estate purchase desirer general extraction means 11 extracts a plurality of candidates by analyzing desired conditions of registered purchase desirers, using a search condition obtained by expanding a search condition set by the search condition setting means 10 to provide a certain width.

In FIG. 2, the property processing means 14 is a means which analyzes desired conditions of a plurality of purchase desirers set using the search condition setting means 10, estate purchase desirer general extraction means 11 and the desirer general extraction means, and which is capable of processing a property corresponding to the arbitrarily set property 7n to match the desired conditions of each of the purchase desirers as much as possible. Thus, the means 14 is a new means enabling the group purchase of purchase desirers.

In FIG. 2, the property processing means 14 notifies a plurality of determined general candidates via the network 6.

In FIG. 1, the estate purchase desirer 4 pays a blockage commission to the estate broker 3 when completion of the contract. The commission is a consideration for the estate purchase desirer 4 achieving the purchase of the property matching the desire. Further, the estate brokers 2 and 3 pay contingent fees to a manager of the estate group purchasing matching system 5. The fees are considerations for improved efficiency in brokerage by the estate brokers 2 and 3 handling estate purchase desirers 4 with high possibilities of completion of a contract.

As described above, according to this embodiment, such effects are provided that the estate purchase desirer 4 is capable of efficiently finding a property matching various desired purchase conditions without repeating trials and errors in property search, the estate sales desirer 1 is capable of early selling a property desired to sell, and that the estate brokers 2 and 3 are capable of having a high close rate per estate purchase desirer 4, and saving a lot of efforts and time required before completion of a contact.

As described above, in the system search apparatus, desired purchase conditions and customer attribute information described by an estate purchase desirer is analyzed and organized in set format, the search condition setting means selects a search condition corresponding to a property “n” arbitrarily selected from the estate sales desirer information database, a plurality of estate purchase desirers is accessed from the estate purchase desirer database based on the search condition, and the estate purchase desirer general extraction means roughly groups purchase desirers from registered estate purchase desirers, using numeric values of priorities of desired conditions of the estate purchase desirers. The desired condition analysis means searches in detail the desired purchase conditions and customer attribute information of the estate purchase desirer candidates to narrow the purchase desirer candidates, and thus groups purchase desirer candidates. Such an effect is thereby provided that a plurality of grouped candidates is capable of achieving purchase of a property generally matching the desired conditions in conjunction with the property processing means.

Thus, by providing the property processing means which determines a property candidate that, each of purchase desirers desires to notify the estate purchase desirers, such effects are obtained that the estate purchase desirer is capable of efficiently finding a property matching various desired purchase conditions without repeating trials and errors in property search, the estate sales desirer is capable of selling a property desired to sell in a short period, and that the estate brokers are capable of having a high close rate per estate purchase desirer, and saving a lot of efforts and time required before completion of a contact.

Such effects are further provided that estate purchase desirers are capable of obtaining information promptly and, that it is possible to perform estate distribution processing efficiently, while the estate purchase desirer is capable of efficiently finding a property matching various desired purchase conditions without repeating trials and errors in property search, the estate sales desirer is capable of early selling a property desired to sell, and the estate brokers are capable of having a high close rate per estate purchase desirer, and saving a lot of efforts and time required before completion of a contact.

Further, the customer condition analysis means analyzes desired purchase conditions and customer information described by a customer in natural language, thereby providing such an effect that the customer is capable of expressing the desired purchase conditions in ordinary sentence without being aware of specific format.

With respect to the desired purchase conditions described in natural language, when priorities are not described, the search condition setting means of the estate purchase desirer analyzes the content of descriptions in natural language, and judges the priorities of the desired purchase conditions from the content suggesting the priorities, thereby providing such an effect that customers are capable of expressing desired purchase conditions in ordinary sentence without being aware of specific format.

Further, when priorities are assigned to the desired purchase conditions, the search condition setting means uses the priorities. When priorities are not assigned, the priorities judged by the search condition setting means are used. When the estate purchase desirer general extraction means cannot judge priorities, the priorities of the desired purchase conditions are determined from the sequence of descriptions of the described desired purchase conditions, thereby providing such an effect that customers are capable of expressing desired purchase conditions in ordinary sentence without being aware of specific format.

There is a further effect that subdivision business owners are capable of reducing the risk in subdivision and expecting increases in profit by effective use of capital.

There is a still further effect that estate purchase brokers expect increases in customer commission earning, because of high close rate of the property that a seller desires to sell.

There is a yet further effect that estate sales brokers expect increases in commission earning, because of high close rate of the property that a buyer desires to purchase.

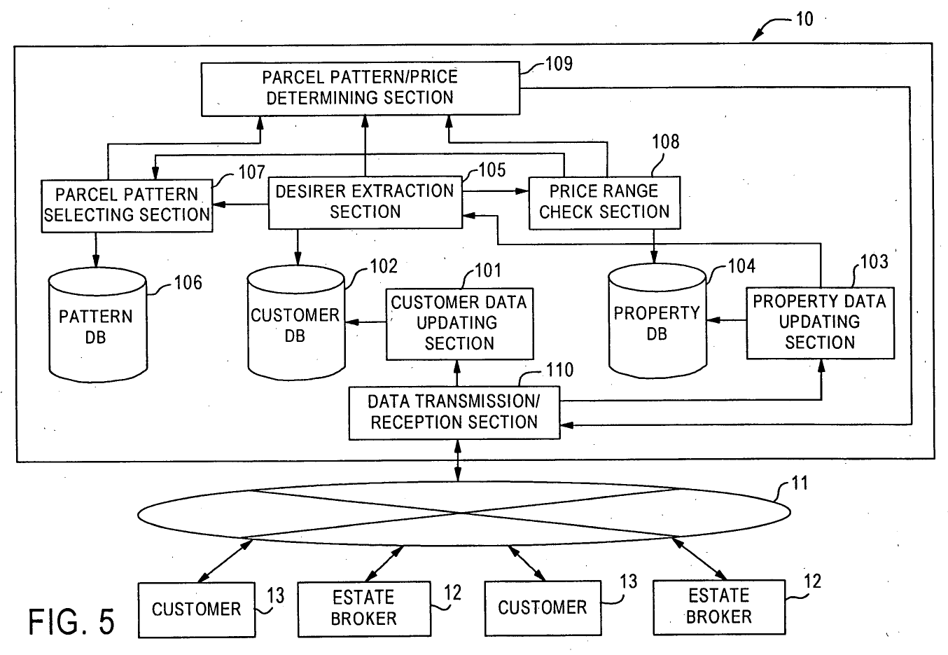

FIGS. 5 to 12 illustrate preferable specific examples including the property processing means.

FIG. 5 is a diagram illustrating a schematic configuration of an estate trading system. The estate trading system as shown in FIG. 5 includes an estate trade management center 40. The estate trade management center 40 is connected to customers (estate purchase desirers) 43 and estate brokers 42 who have properties for sale via a network 41 such as the internet. Accordingly, the customers 43 register customer information with the estate trade management center 40 via the network 41, and the estate trade management center 40 provides information (such as a parcel pattern and price) of a property that the customers desire to the customers 43. Further, the estate brokers 42 provide information of properties for sale to the estate trade management center 40 via the network 41.

The estate trade management center 40 is principally comprised of a customer data updating section 101, customer database (customer DB) 102, property data updating section 103, property database (property DB) 104, desirer extraction section 105, parcel pattern database (pattern DB) 106, parcel pattern selecting section 107, price range check section 108, parcel pattern/price determining section 109 and data transmission/reception section 110.

Data transmission/reception section 110 receives property data such as properties for sale from the estate brokers 42 and customer data from the customers 43 via the network 41, while transmitting information such as a parcel pattern and price determined in the estate trade management center 40 to the customers 43 via the network 41.

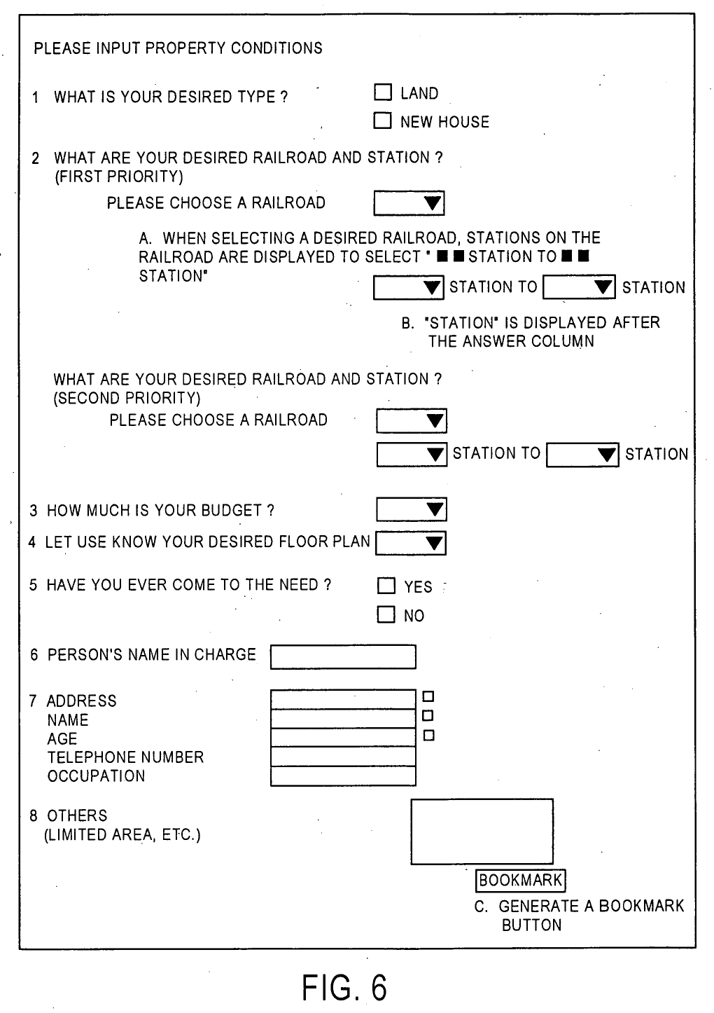

The customer data updating section 101 receives data input by the customers 43 on the site to write in the customer DB 102. By this means, the customer data updating section 101 manages the customer data of customers 43 registered with the system. More specifically, for example, on an input screen on the site as shown in FIG. 6, the customer inputs a type of property, desired railroad and station, budget (desired price), floor plan of a house, person in charge, personal information (such as an address, name, age, occupation and telephone number) and soon. Based on the input data, the customer DB 102 stores the data input on the site for each customer.

The property data updating section 103 receives the property data such as properties for sale input by the estate brokers 42 on the site to write in the property DB 104. By this means, the property data updating section 103 manages the property data that the estate brokers provide to the system.

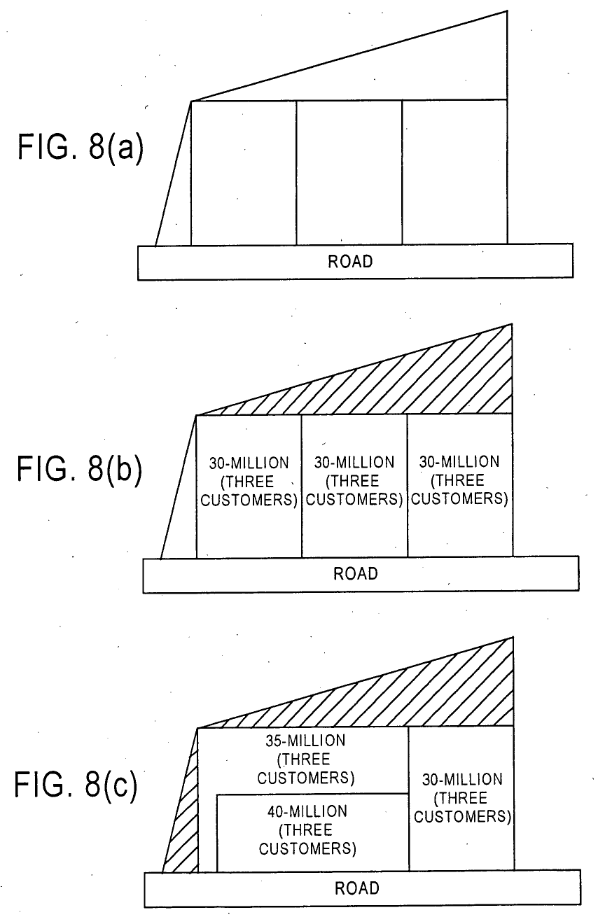

In addition, used for the property data is a beforehand trimmed (shaped) property (in the shape of a rectangle) enabling easy parceling (see FIG. 8) Accordingly, the property data includes data such as a frontage and depth of lot in the property trimmed in the shape of a rectangle. The trimming processing may be carried out mutually by an input means not shown, or performed automatically by the property data updating section 103. Otherwise, the estate broker 42 may transmit the property data of a trimmed property.

The desirer extraction section 105 extracts customers who desire the property from the customer DB 102 based on the property data from the estate broker 42. In other words, the desirer extraction section 105 extracts from the customer DB 102 customers who describe the railroad and station nearby the property provided by the estate broker 42 as the desired railroad and station. In this case, it may be possible to extract all the customers who describe the railroad and station nearby the provided property as the desired railroad and station, or it may be possible that the maximum number of extracted customers is beforehand set and that a predetermined number of customers are only extracted. In the case of limiting customers to the predetermined number, it may be possible to extract customers in ascending order of data when the customer registered the system, or extract based on other information such as the price.

The price range check section 108 extracts a price range that customers more than the predetermined number desire among the customers extracted in the desirer extraction section 105. In other words, the price range check section 108 obtains the distribution of desired prices from the customer database 102, extracts a price range having the maximum number of customers on the distribution, and checks the tendency of the distribution of the price range. More specifically, the section 108 checks whether many customers desire a specific price or whether a certain number of customers are distributed on a plurality of desired prices. Then, the price range check section 108 transmits results of the check to parcel pattern selecting section 107 as information for parcel selection. In other words, the price range check section 108 obtains pattern selection reference information (the results of the check) to select a parcel pattern of the provided property.

Herein, extracted is a price range that customers more than the predetermined number desire, and the distribution of the extracted price range information is used as the pattern selection reference information. However, if the parcel pattern selecting section 107 described below is capable of selecting a parcel pattern, the pattern selection reference information is not limited to the aforementioned information. For example, the pattern selection reference information may be obtained in consideration of surrounding environments such as the direction and sunny aspect.

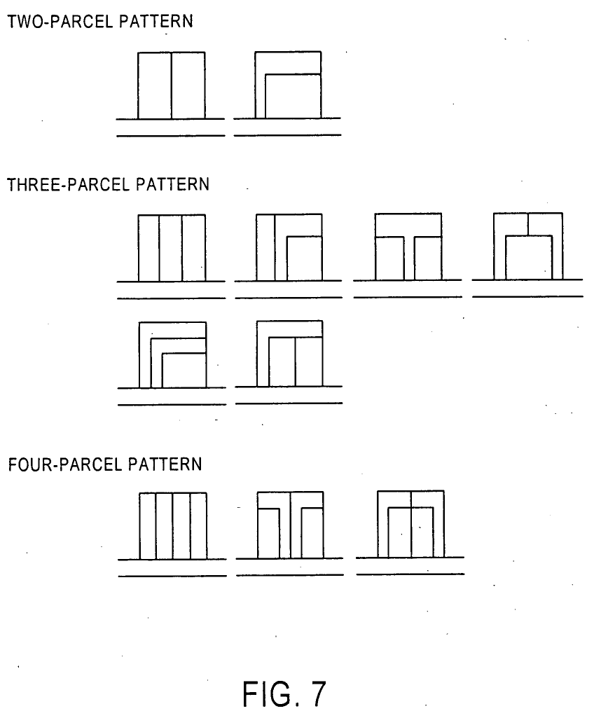

The parcel pattern selecting section 107 selects a parcel pattern from the parcel pattern database 106 based on the number of extracted desirers and information of the price range of the desirers. The parcel patterns are, for example, considered as shown in FIG. 7, and stored beforehand in the parcel pattern database 106. To meet such a requirement that each parcel faces to a road, considered are patterns as shown in FIG. 7. While patterns up to four parcels are shown in FIG. 7, the parcel pattern database 106 stores patterns with five or more parcels. For example, in the case of patterns with five parcels, it is possible to form such patterns by combining a two-parcel pattern and a three-parcel pattern. In this way, patterns with five or more parcels are formed by combining a plurality of parcel-patterns.

The parcel pattern/price determining section 109 performs matching between customers and parcels based on the pattern information selected in the parcel pattern selecting section 107, desirers extracted in desirer extraction section 105, and the price range information extracted in the price range check section 108. Then, when matching is obtained, the parcel pattern/price determining section 109 transmits the determined information (such as parcels and prices) to the customers 43 from the data transmission/reception section 110 via the network 41.

In the estate trading system according to the present invention with the aforementioned constitution, customers are extracted whose desired locations match a location of the provided property, the pattern selection reference information is obtained based on the distribution of price ranges of the extracted customers, a parcel pattern of the provided property is selected based on the pattern selection reference information and customer information, and the parcel and price information is provided to the customers based on the parcel pattern, pattern selection reference information and customer information.

By this means, the provided property is checked against desired conditions to perform matching, and it is thereby possible to search for a property matching the desired conditions promptly, and to implement a contract of estate trade early. As a result, it is possible to perform matching between a for-sale property and estate purchase desirers promptly and efficiently.

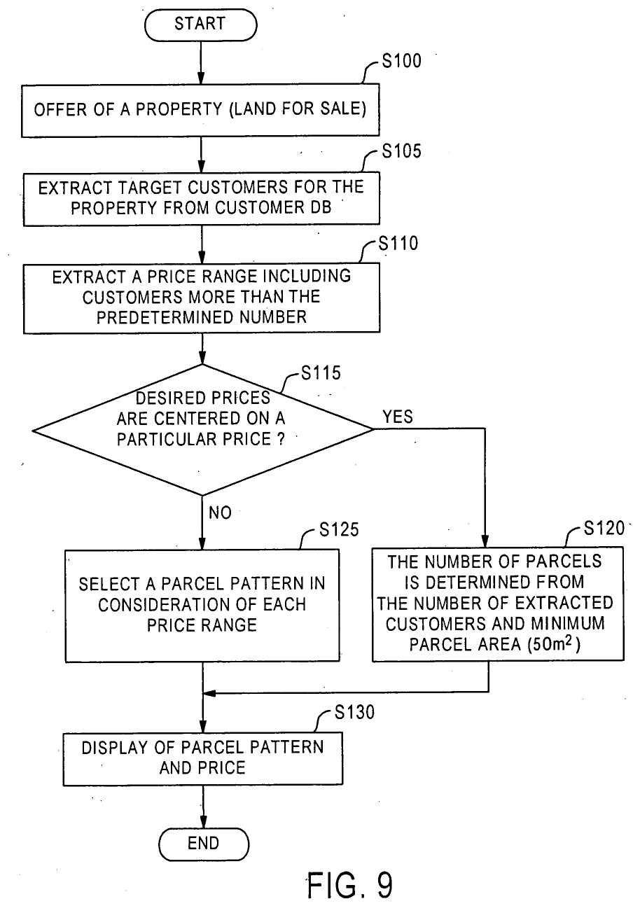

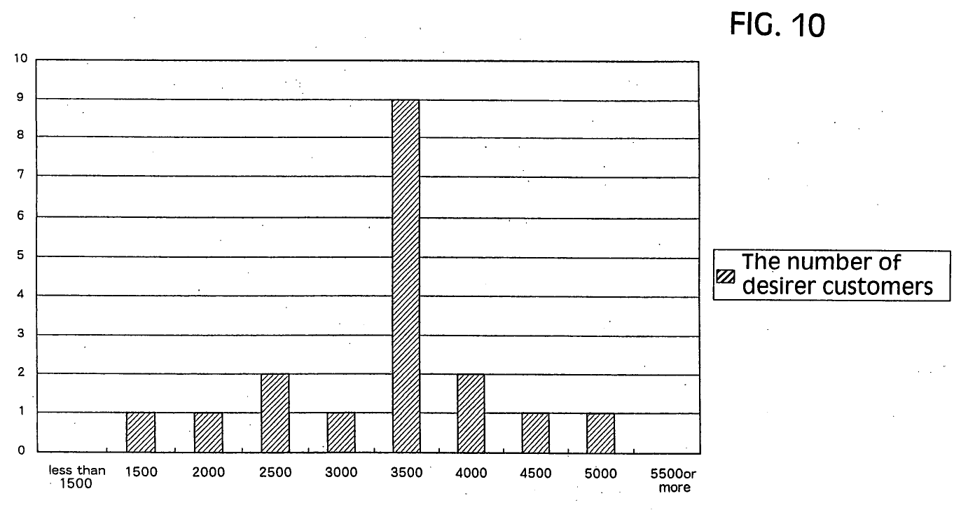

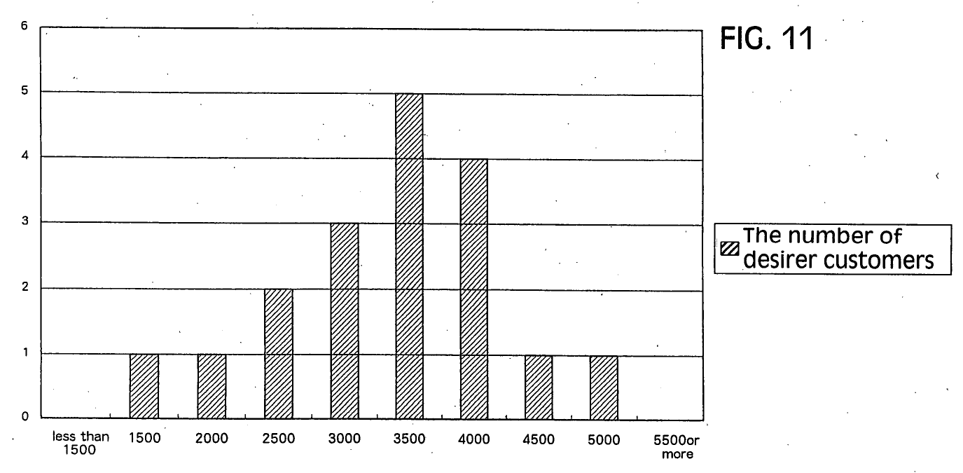

Specific examples of the estate trading system with the aforementioned constitution will be described below with reference to FIGS. 8 to 11. FIGS. 8(a) to 8(c) are views to explain parcels in the estate trading system according to one embodiment of the present invention. FIG. 9 is a flowchart to explain procedures in the estate trading system according to the one embodiment of the present invention. FIGS. 10 and 11 are graphs showing distributions of the number of desirers with respect to a property to sell used in the estate trading system according to the one embodiment of the present invention.

Descriptions are given according to the flowchart in FIG. 9. First, in step S100, the estate broker 42 offers a property (land targeted for sale). The property information is transmitted from the estate broker 42 to the data transmission/reception section 110 in the estate trade management center 40. The data transmission/reception section 110 outputs the property information to the property data updating section 103. The property data updating section 103 stores the property information in the property database 104. At this point, the property data updating section 103 performs trimming on the property. In other words, when the property as shown in FIG. 8(a) is offered, the property data updating section 103 performs trimming on the property in the shape of a rectangle (white portion) to facilitate parceling as shown in FIG. 8(b) or 8(c). Further, the property data updating section 103 outputs the property information to the desirer extraction section 105.

In step S105, the desirer extraction section 105 extracts customers who desire the offered property. In other words, the desirer extraction section 105 extracts customers (target customers) who desire the railroad and station of the offered property as the desired railroad and station from the customer database 102. More specifically, the section 105 checks the railroad and station included in the property information against railroads and stations included in the customer information stored in the customer database 102, and extracts all matching customers. The information of the extracted customers (desirers) is output to the price range check section 108, parcel pattern selecting section 107, and parcel-pattern/price determining section 109.

In step S110, the price range check section 108 checks a price range including a predetermined number of customers. For example, the price range check section 108 checks the distribution of desired prices of the customers who desire the offered property. More specifically, the price range check section 108 checks the distribution based on the desired prices included in the customer information. Results are assumed as shown in FIG. 10 or 11. In FIG. 10 an extremely large number of customers offer 35-million yens as a desired price, while in FIG. 11 a large number of customers offer 30-million yens, 35-million yens, or 40-million yens as a desired price.

In step S115, the price range check section 108 judges the tendency of the distribution of desired prices. More specifically, the section 108 judges whether or not the desired prices are centered on a particular price.

In the case where the desired prices are centered on a particular price, in other words, in the case of the distribution as shown in FIG. 10, determined in step S120 is the number of parcels from the number of extracted customers and the minimum parcel area (50 m²). For example, in FIG. 11, nine customers offer 35-milion yens as a desired price, and therefore, are equally sorted into three groups with three people. Then, the price range check section 108 outputs as the pattern selection reference information the information including the tendency of the distribution (FIG. 10) with the centered particular price, the centered price, and the number of extracted customers of three groups each with three customers to the parcel pattern selecting section 107 and parcel pattern/price determining section 109.

The parcel pattern selecting section 107 selects a parcel pattern based on the pattern selection reference information. In other words, since the pattern selection reference information indicates that the distribution is as shown in FIG. 10, the price is 35-million yens, and that three groups each have three customers, the section 107 selects an equal parcel pattern based on the information while referring to the parcel pattern database 106. More specifically, the section 107 selects the parcel pattern as shown in FIG. 8(b). The parcel pattern information is output to parcel pattern/price determining section 109.

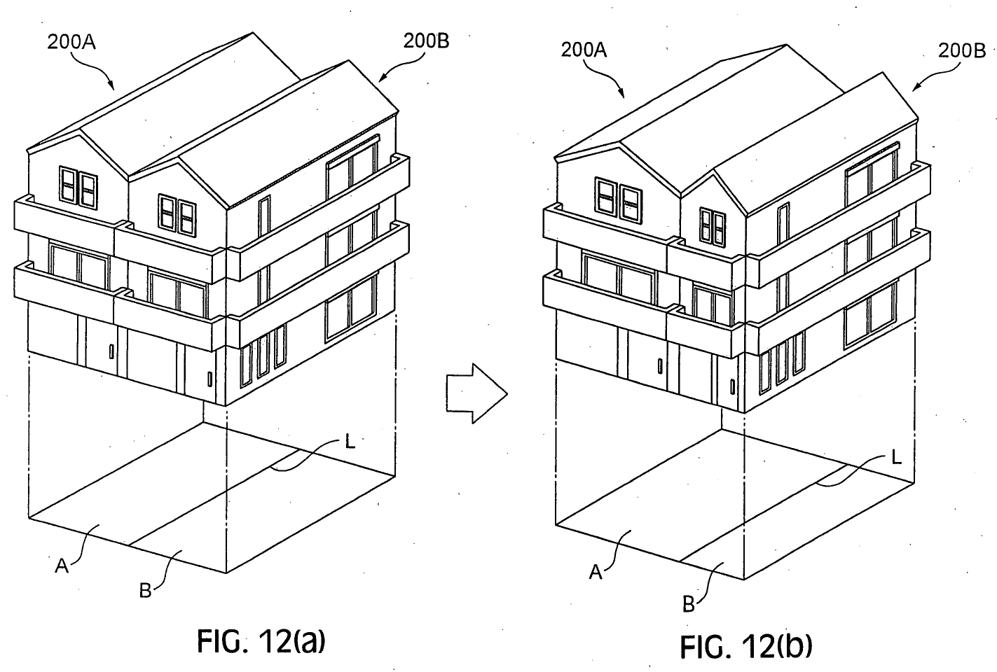

In step S130, the parcel pattern/price determining section 109 determines the parcel pattern and price based on the parcel pattern information, customer information, and pattern selection reference information. In addition, at this point, the parcel pattern/price determining section 109 serves as the property processing means, and may process the property to match desires of a plurality of customers (estate purchase general candidates). More specifically, based on the pattern selection reference information and the customer information, for example, the parcel pattern/price determining section 109 may form 3-D house images 200A and 200B respectively in parcels A and B as shown in FIG. 12(a), or may change the property line of the parcels A and B as shown in FIG. 12(b). Further, according to the change of the property line L of the parcels A and B, sizes of the 3-D house images 200A and 200B may be changed.

The parcel and price information is transmitted to the customers 43 from the data transmission/reception section 110 via the network 41. The provision of the parcel/price information may be carried out on the network as described above, or by mail.

Meanwhile, when the desired prices are not centered on a particular price, in other words, in the case of the distribution as shown in FIG. 11, determined in step S125 is the number of parcels from the number of extracted customers. For example, in FIG. 11, there are three customers with 30-milion yens as a desired price, five customers with 35-million yens as a desired price and four customers with 40-million yens as a desired price. In this case, parcels are graded into a low-price parcel, middle-price parcel and high-price parcel. The grading is determined as appropriate in consideration of surrounding environments such as the direction and sunny aspect. The grouping is thus carried out such that the low-price parcel (30-million yens) includes three customers, the middle-price parcel (35-million yens) includes three customers and that the high-price parcel (40-million yens) includes three customers.

The price range-check section 108 outputs as the pattern selection reference information the information including the tendency of the distribution (FIG. 11) without any centered particular price, a plurality of prices (30-million yens, 35-million yens and 40-million yens), and the number of extracted customers of three groups each with three customers to the parcel pattern selecting section 107 and parcel pattern/price determining section 109.

The parcel pattern selecting section 107 selects a parcel pattern based on the pattern selection reference information. In other words, since the pattern selection reference information indicates that the distribution is as shown in FIG. 11, the prices are 30-million yens, 35-million yens and 40-million yens, and that groups are the low-price parcel including three customers, middle-price parcel including three customers and high-price parcel including three customers, the section 107 selects a parcel pattern based on the information while referring to the parcel pattern database 106. More specifically, the section 107 selects the parcel pattern as shown in FIG. 8(c). The parcel pattern information is output to parcel pattern/price determining section 109.

In step S130, the parcel pattern/price determining section 109 determines the parcel pattern and price based on the parcel pattern information, customer information, and pattern selection reference information. Then, the parcel pattern and price information is transmitted to the customers 43 from the data transmission/reception section 110 via the network 41. The provision of the parcel/price information may be carried out on the network as described above, or by mail.

The customers 43 having received the information of the parcel pattern and price send a response as to whether or not to purchase to the estate broker 42 via the estate trade management center 40. Subsequently, negotiations start on a contract between the estate broker 42 and customers 43. In this way, it is made possible to implement estate trade contracts promptly and efficiently. In addition, the response as to whether or not to purchase may be sent by returning an e-mail with the information of the parcel pattern and price attached thereto, or carried out on the site of the system.

The present invention is not limited to the aforementioned embodiment, and is capable of being carried into practice with various modifications thereof. For example, items to input, and layout on an input screen on the site and parcel patterns are not limited to the above-mentioned embodiment, and are capable of being modified in various manners.

The above-mentioned embodiment describes the case where a parcel pattern is determined in consideration of a price range when a plurality of desirers is extracted on a property to sell. However, in the present invention, when a plurality of desirers is extracted on a property to sell, a parcel pattern may be determined in consideration of another condition, for example, surrounding environments such as the direction and sunny aspect.

Further, the above-mentioned embodiment describes the case of performing in hardware the processing for extracting desirers and then selecting a parcel pattern. However, in the present invention, the processing for extracting desirers and then selecting a parcel pattern may be performed in software. For example, it may be possible that the processing for extracting desirers and then selecting a parcel pattern is programmed, the program is stored in ROM, and that the operation is performed by instructions of a CPU according to the program. Further, it may be possible that the program is stored in a computer-readable storage medium, the program in the storage medium is stored in RAM of a computer, and that the operation is performed according to the program. Such cases also exhibit the same effects as in the above-mentioned embodiment.

1. An estate group purchasing matching system comprising:
property data storage means for generating a database of for-sale property information provided from estate sales desirers, estate purchase brokers and others, on a network where the estate sales desirers and the estate purchase brokers are connected to enable data communications there between;
estate purchase desirer data input means for generating a database of information of desired purchase conditions of estate purchase desirers and attribute information on the estate purchase desirers input from a plurality of terminal apparatuses, on a network where the estate purchase desirers and the estate purchase brokers are connected to enable data communications there between;
search condition setting means for analyzing the desired purchase conditions of the estate purchase desirers and the attribute information on the estate purchase desirers on each property of the for-sale property information database in the property data storage means, and setting a search condition corresponding to the each property from the estate purchase desirer information database generated by the estate purchase desirer data input means;
estate purchase desirer general extraction means for searching general information of a plurality of estate purchase desirer candidates based on the search condition set by the search condition setting means, and extracting a plurality of estate purchase general candidates;
desired condition analysis means for analyzing desired purchase conditions of the plurality of estate purchase general candidates extracted by the estate purchase desirer general extraction means corresponding to the each property of the, for-sale property information database, and setting combinations thereof; and
property processing means for processing the property to enable matching with desires of the plurality of estate purchase general candidates.

2. The estate group purchasing matching system according to claim 1, wherein the for-sale property information databased by the property data storage means includes at least a database storing attribution data such as an application, a type, location information, owner information, information of price per unit area and environment information of each property, and a map database with which is registered data of maps on which properties are present.

3. The estate group purchasing matching system according to claim 1, wherein the information of desired purchase conditions of estate purchase desirers databased by the estate purchase desirer data input means includes at least information as to whether a desired property is a land or a house with the land, information of desired railroad, information of desired station, information of desired price of a property, and personal attribute information of desirers, and the attribute information on the estate purchase desirers includes at least a name, an age, a current address, a telephone number, an e-mail address, a family structure, occupation, place of work and years of continuous employment, annual income, presence or absence of initial deposit, motive of desire for purchase and whether the current house is an own house or not.

4. The estate group purchasing matching system according to claim 1, wherein the search condition setting means analyzes the desired purchase conditions of the estate purchase desirers and the attribute information of the purchase desirers on each property of the for-sale property using the estate purchase desirer information database, and extracting a search condition by quantifying limitations in the attribute information and further quantifying priorities of the desired conditions.

5. The estate group purchasing matching system according to claim 1, wherein the estate purchase desirer general extraction means extracts general information of a plurality of estate purchase desirers using the search condition setting means, and is capable of simulating possible combination patterns.

6. The estate group purchasing matching system according to claim 1, further comprising:
desired condition analysis means for analyzing in detail the conditions of each of the plurality of estate purchase general candidates extracted by the estate purchase desirer general extraction means with respect to each property of the for-sale property information database to narrow combinations.

7. The estate group purchasing matching system according to claim 6, wherein with respect to each property of the for-sale property information database, the property processing means processes the property so that a designated candidate for-sale property is allocated to match as much as possible with needs of a plurality of estate purchase candidates selected by the desired condition analysis means.

8. The estate group purchasing matching system according to claim 1, wherein the property processing means comprises customer information storage means for storing customer information including desired locations and desired prices, customer extraction means for extracting customers whose desired location is a location of an offered property, pattern selection reference information acquiring means for acquiring pattern selection reference information based on a distribute of desired prices of extracted customers, parcel pattern selecting means for selecting a parcel pattern of the offered property based on the pattern selection reference information and the customer information, and means for providing information of parcel and price to the extracted customers based on the parcel pattern, the pattern selection reference information and the customer information.

9. The estate group purchasing matching system according to claim 8, wherein the pattern selection reference information includes information as to whether desired prices of the extracted customers are centered on a particular price.

10. The estate group purchasing matching system according to claim 9, wherein when the desired prices of the extracted customers are centered on a particular price, the parcel pattern selecting means selects a parcel pattern with equally divided parcels.

11. The estate group purchasing matching system according to claim 9, wherein when the desired prices of the extracted customers are not centered on a particular price, the pattern selection reference information acquiring means performs grading corresponding to the desired prices of the extracted customers, and the parcel pattern selecting means selects a parcel pattern in consideration of the grading.

12. The estate group purchasing matching system according to claim 8, wherein the offered property is trimmed in the shape of a rectangle.

13. The estate group purchasing matching system according to claim 8, wherein 3-D house images are displayed in parcels of the offered property.

14. The estate group purchasing matching system according to claim 8, wherein a property line of parcels of the offered property is changed based on the pattern selection reference information and the customer information.

15. The estate group purchasing matching system according to claim 8, wherein 3-D house images are displayed in parcels of the offered property, a property line of parcels of the offered property is changed based on the pattern selection reference information and the customer information, and display of the 3-D images change according to the change in the property line.
